(19) United States
(12) Patent Application Publication
(10) Pub. No.: US 2025/0078233 A1
(43) Pub. Date: Mar. 6, 2025

(54) Multi-Modal Feedback for Mobile Dimensioning

(71) Applicant: Zebra Technologies Corporation, Lincolnshire, IL (US)

(72) Inventors: Raghavendra Tenkasi Shankar, Holbrook, NY (US); Patrick B. Tilley, Coram, NY (US)

(21) Appl. No.: 18/243,050

(22) Filed: Sep. 6, 2023

(51) Int. Cl. G06T 7/00; G06T 7/60

(52) U.S. Cl. CPC G06T 7/0002; G06T 7/60; G06T 2207/10028; G06T 2207/30168

(57) ABSTRACT

A method includes: capturing a three-dimensional image depicting an object; capturing a two-dimensional image depicting the object; determining a region of interest in the two-dimensional image, the region of interest containing the object; determining, based on the region of interest from the two-dimensional image, a quality indicator corresponding to the three-dimensional image; comparing the quality indicator to a predetermined threshold; and when the quality indicator does not satisfy the predetermined threshold, generating a positional notification.

### BACKGROUND

Depth sensors such as time-of-flight (ToF) sensors can be deployed in mobile devices such as handheld computers, and employed to capture point clouds of objects (e.g., boxes or other packages), from which object dimensions can be derived. ToF sensors, however, may be susceptible to reduced capture quality caused by multipath reflections, reflective surfaces, dark-colored surfaces, and the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a computing device for dimensioning an object.

FIG. 2 is a flowchart of a method of multi-modal feedback for mobile dimensioning.

FIG. 3 is a diagram of an example image and an example point cloud captured by the device of FIG. 1.

FIG. 4 is a diagram illustrating an example performance of blocks 210 and 215 of the method of FIG. 2.

FIG. 5 is a diagram illustrating an example performance of block 215 of the method of FIG. 2.

FIG. 6 is a diagram illustrating another example performance of blocks 210 and 215 of the method of FIG. 2.

FIG. 7 is a diagram illustrating a further example performance of blocks 210 and 215 of the method of FIG. 2

FIG. 8 is a diagram illustrating example performances of blocks 225 and 230 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: capturing a three-dimensional image depicting an object; capturing a two-dimensional image depicting the object; determining a region of interest in the two-dimensional image, the region of interest containing the object; determining, based on the region of interest from the two-dimensional image, a quality indicator corresponding to the three-dimensional image; comparing the quality indicator to a predetermined threshold; and when the quality indicator does not satisfy the predetermined threshold, generating a positional notification.

Additional examples disclosed herein are directed to a computing device, comprising: a sensor assembly; and a processor configured to: capture, via the sensor assembly, a three-dimensional image depicting an object; capture, via the sensor assembly, a two-dimensional image depicting the object; determine a region of interest in the two-dimensional image, the region of interest containing the object; determine, based on the region of interest from the two-dimensional image, a quality indicator corresponding to the three-dimensional image; compare the quality indicator to a predetermined threshold; and when the quality indicator does not satisfy the predetermined threshold, generate a feedback notification.

Further examples disclosed herein are directed to a method comprising: obtaining a point cloud depicting an object; obtaining a two-dimensional image of the object; detecting the object in the two-dimensional image; based on the detected object in the two-dimensional image, determining a quality indicator configured to indicate a likelihood that dimensions of the object can be obtained from the point cloud; and selecting, based on the quality indicator, between (i) generating feedback to reposition a sensor relative to the object and (ii) obtaining dimensions of the object from the point cloud.

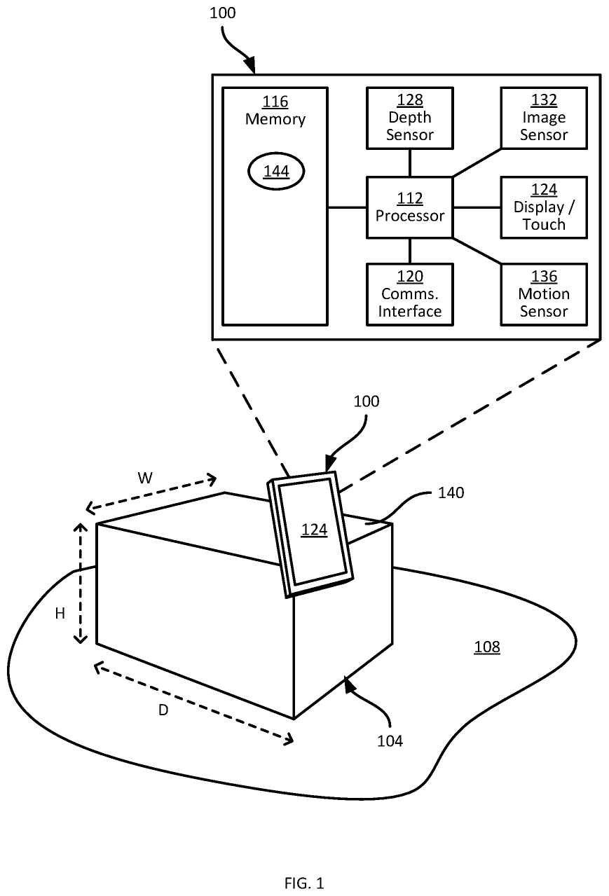

FIG. 1 illustrates a computing device 100 configured to capture sensor data depicting a target object 104 within a field of view (FOV) of one or more sensors of the device 100. The computing device 100, in the illustrated example, is a mobile computing device such as a tablet computer, smartphone, or the like. The computing device 100 can be manipulated by an operator thereof to place the target object 104 within the FOV(s) of the sensor(s), to capture sensor data for subsequent processing as described below. In other examples, the computing device 100 can be implemented as a fixed computing device, e.g., mounted adjacent to an area in which target objects 104 are placed and/or transported (e.g., a staging area, a conveyor belt, a storage container, or the like).

The object 104, in this example, is a parcel (e.g., a cardboard box, pallet, or the like), although a wide variety of other objects can also be processed as discussed herein. The sensor data captured by the device 100 can include a point cloud, and a two-dimensional image. To capture the point cloud, the computing device 100 can be configured to capture a plurality of depth measurements, each corresponding to a pixel of a depth sensor. The depth measurements and sensor pixel coordinates can then be transformed, e.g., based on calibration parameters for the depth sensor, into a plurality of points. Each point is defined by three-dimensional coordinates according to a predetermined coordinate system. The point cloud therefore defines three-dimensional positions of corresponding points on the target object 104 and any other objects within the FOV of the depth sensor, such as a support surface 108 supporting the object 104.

To capture the two-dimensional image, the computing device 100 can be configured to capture a two-dimensional array of pixels via an image sensor. Each pixel in the array can be defined by a color value and/or a brightness value. For instance, the image can include a color image (e.g., an RGB image).

The device 100 (or in some examples, another computing device such as a server, configured to obtain the sensor data from the device 100) can be configured to determine dimensions from the point cloud mentioned above, such as a width “W”, a depth “D”, and a height “H” of the target object 104. The dimensions determined from the point cloud can be employed in a wide variety of downstream processes, such as optimizing loading arrangements for storage containers, pricing for transportation services based on parcel size, and the like.

Certain internal components of the device 100 are also shown in FIG. 1. For example, the device 100 includes a processor 112 (e.g., a central processing unit (CPU), graphics processing unit (GPU), and/or other suitable control circuitry, microcontroller, or the like). The processor 112 is interconnected with a non-transitory computer readable storage medium, such as a memory 116. The memory 116 includes a combination of volatile memory (e.g. Random Access Memory or RAM) and non-volatile memory (e.g. read only memory or ROM, Electrically Erasable Programmable Read Only Memory or EEPROM, flash memory). The memory 116 can store computer-readable instructions, execution of which by the processor 112 configures the processor 112 to perform various functions in conjunction with certain other components of the device 100. The device 100 can also include a communications interface 120 enabling the device 100 to exchange data with other computing devices, e.g., via local and/or wide area networks, short-range communications links, and the like.

The device 100 can also include one or more input and output devices, such as a display 124, e.g., with an integrated touch screen. In other examples, the input/output devices can include any suitable combination of microphones, speakers, keypads, data capture triggers, or the like.

The device 100 further includes a depth sensor 128, controllable by the processor 112 to capture point cloud data as set out above. The depth sensor 128 can include a time-of-flight (ToF) sensor, a stereo camera assembly, a LiDAR sensor, or the like. The depth sensor 128 can be mounted on a housing of the device 100, for example on a back of the housing (opposite the display 124, as shown in FIG. 1) and having an optical axis that is substantially perpendicular to the display 124. The device 100 also includes an image sensor 132, such as a complementary metal-oxide semiconductor (CMOS) or charge-coupled device (CCD) camera. Although the sensors 128 and 132 are described as physically separate sensors herein, in other examples the sensors 128 and 132 can be combined. The sensors 128 and 132 may therefore also be referred to as a sensor assembly, which can be either separate depth and image sensors, or a single combined sensor. For example, certain depth sensors, such as ToF sensors, can capture both point clouds and two-dimensional images.

The device 100 can further include a motion sensor 136, such as an inertial measurement unit (IMU) including one or more accelerometers and/or one or more gyroscopes. The motion sensor 136 can generate data corresponding to movement of the device 100.

The depth sensor 128, when implemented as a ToF sensor, can include a laser emitter configured to illuminate a scene (e.g., with infrared light), and a sensor (such as an infrared-sensitive image sensor) configured to capture reflected light from such illumination. The depth sensor 128 can further include a controller configured to determine a depth measurement for each captured reflection according to the time difference between illumination pulses and reflections. The depth measurement indicates the distance between the depth sensor 128 itself and the point in space where the reflection originated. Each depth measurement represents a point in a resulting point cloud. The depth sensor 128 and/or the processor 112 can be configured to convert the depth measurements into points in a three-dimensional coordinate system to generate the point cloud, from which dimensions of the object 104 can be determined. For example, determining dimensions of the object 104 can include detecting the support surface 108 and an upper surface 140 of the object 104 in the point cloud. The height H of the object 104 can be determined as the perpendicular distance between the upper surface 140 and the support surface 108. The width W and the depth D can be determined as the dimensions of the upper surface 140. In other examples, the dimensions of the object 104 can be determined by detecting intersections between planes forming the surfaces of the object 104, by calculating a minimum hexahedron that can contain the object 104, or the like.

Detection of the object 104 and dimensioning of the object 104 based on a point cloud captured via the depth sensor 128 can be affected by a wide variety of factors. For example, if the depth sensor 128 is placed too close to the object 104, the object 104 may be subject to excessive reflected light (e.g., glare) that reduces the accuracy of depth measurements. In other examples, if the depth sensor 128 is too distant from the object 104, the point cloud may contain blank regions with no depth measurements for certain portions of the object.

The position of the device 100 relative to the object 104, in other words, can affect the ability of the device 100 to generate dimensions from a point cloud captured via the depth sensor 128. Positioning of the device 100 relative to the object 104 can be assisted by capturing successive two-dimensional images (e.g., color images as noted earlier) and presenting the two-dimensional images substantially in real-time on the display 124, e.g., implementing an electronic viewfinder with the image sensor 132 and the display 124. The two-dimensional images may, however, be less susceptible to missing pixels or inaccurately captured pixels as a result of the positioning of the object 104, ambient lighting, or the like. In other words, although the point cloud captured via the depth sensor 128 may include inaccurately positioned points, or may have missing points, the two-dimensional image captured via the image sensor 132 (e.g., simultaneously with the point cloud) may include accurate color and/or intensity data for those points. An operator of the device 100 may therefore be unlikely to determine, from the electronic viewfinder mentioned above, when point cloud accuracy is insufficient for accurate dimensioning. The device 100 therefore implements certain actions to provide feedback, e.g., to the operator of the device 100, indicating when the device 100 and/or object 104 should be re-positioned relative to each other to improve dimensioning accuracy.

The memory 116 stores computer readable instructions for execution by the processor 112. In particular, the memory 116 stores a dimensioning application 144 which, when executed by the processor 112, configures the processor 112 to process point cloud data captured via the depth sensor assembly 128 to detect the object 104 and determine dimensions (e.g., the width, depth, and height shown in FIG. 1) of the object 104. In further examples, the application 144 can be implemented by one or more specially designed hardware and firmware components, such as FPGAs, ASICs and the like. The application 144 also configures the device 100 to determine, from a two-dimensional image captured via the image sensor 132, a quality indicator corresponding to a point cloud captured via the depth sensor 128. Based on the quality indicator, the device 100 can determine whether to generate feedback, e.g., instructing an operator to reposition the device 100 relative to the object 104.

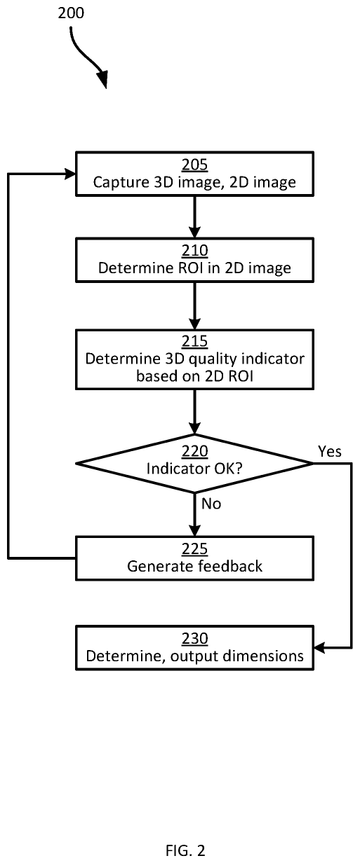

Turning to FIG. 2, a method 200 of multi-model feedback for mobile dimensioning is illustrated. The method 200 is described below in conjunction with its performance by the device 100, e.g., to dimension the object 104. It will be understood from the discussion below that the method 200 can also be performed by a wide variety of other computing devices including or connected with depth sensors and images sensors functionally similar to the sensors 128 and 132 mentioned in connection with FIG. 1.

At block 205, the device 100 is configured to capture three-dimensional image, e.g., by capturing a plurality of depth measurements and generating a point cloud depicting the object 104 therefrom. The device 100 is also configured to capture a two-dimensional image depicting the object 104. For example, the processor 112 can control the depth sensor 128 to capture the point cloud, and the image sensor 132 to capture the 2D image. The point cloud and 2D image can be captured substantially simultaneously. For example, the device 100 can initiate the capture of a sequence of point clouds and 2D images at a suitable frame rate (e.g., set based on the computational capabilities of the device 100). The processor 112 can present each captured 2D image on the display 124, e.g., to implement the previously mentioned electronic viewfinder function.

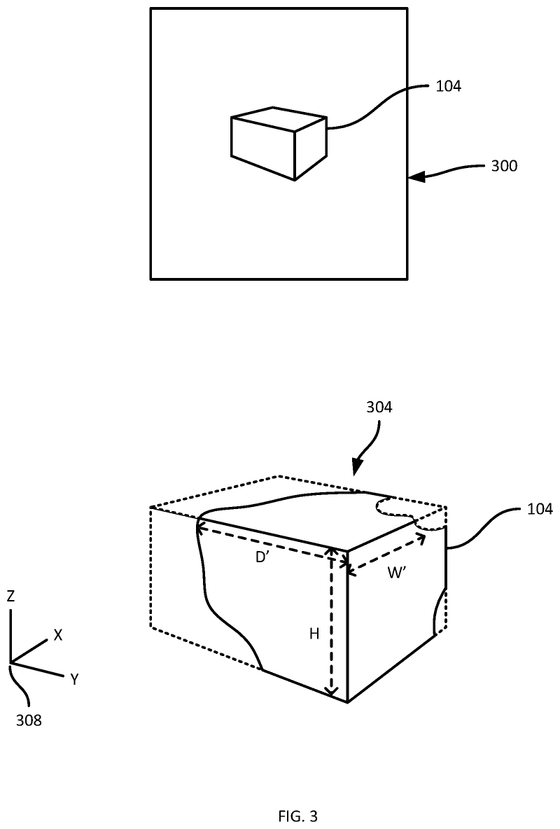

Turning to FIG. 3, an example 2D image 300 and an example point cloud 304 are illustrated, as captured at block 205. The image 300 depicts the object 104 (the support surface 108 is omitted for clarity of illustration). The point cloud 304, however, depicts only a portion of the object 104. Portions of the object 104 shown in solid lines are represented in the point cloud 304, e.g., as points in a coordinate system 308, while portions of the object 104 shown in dashed lines are not represented in the point cloud 304. Portions of the object 104 may be missing from the point cloud 304 due to distance of the object 104 from the depth sensor 128, or various other conditions. The example shown in FIG. 3 is exaggerated for illustration, and it will be understood that in practice the point cloud 304 may include points in the regions illustrated as being empty, although the number and/or accuracy of those points may be suboptimal.

As will be understood from FIG. 3, it may be possible to derive the height H of the object 104 from the point cloud 304, but the width W and the depth D may not be accurately derivable. For example, a width W′ and a depth D′ may be determined from the point cloud 304, based on the incomplete representation of the object 104. The width W′ and the depth D′, however, do not accurately reflect the true width W and depth D of the object 104.

Returning to FIG. 2, at block 210, the device 100 is configured to determine a region of interest (ROI) in the 2D image 300 that contains the object 104. The ROI, in other words, substantially delimits the object 104 from a remainder of the image 300. For example, the processor 112 can be configured to execute one or more segmentation operations to detect the object 104 in the 2D image 300. Examples of such segmentation operations include machine-learning based segmentation models such as You Only Look Once (YOLO). Various other models can be used for segmentation, such as a region-based convolutional neural network (R-CNN), a Fast-CNN, or the like. Various other segmentation operations can also be employed at block 210, including thresholding operations, edge detection operations, region growing operations, and the like. The determination of the region of interest is performed using the 2D image 300, rather than the point cloud 304, because the 2D image 300 is more likely to accurately represent the boundaries of the object 104 than the point cloud 304 under a greater range of conditions (e.g., lighting, distance between the device 100 and the object 104, and the like).

The region of interest determined at block 210 can include a bounding box defined in 2D image coordinates within the 2D image 300. At block 215, the device 100 is configured to determine a quality indicator corresponding to the point cloud 304, based on the 2D region of interest from block 210. The quality indicator, as discussed below, is then evaluated by the device 100 to assess a likelihood that the dimensions of the object 104 can be successfully determined from the point cloud 304. At block 220, the device 100 is configured to determine whether the quality indicator satisfies one or more predetermined thresholds.

When the quality indicator satisfies the one or more predetermined thresholds, the position of the device 100 relative to the object 104 is such that the point cloud 304 is likely sufficiently complete to determine dimensions of the object 104. When the quality indicator does not satisfy the predetermined threshold(s), however, the position of the device 100 relative to the object 104 may be such that the point cloud 304 is likely to contain empty regions, sparse regions, or the like, that reduce the likelihood of successfully dimensioning the object 104.

The device 100 therefore, in response to a negative determination at block 220, proceeds to block 225 and generates feedback, such as a positional feedback notification. The feedback generated at block 225 can be generated via the display 124 and/or another suitable output of the device 100 (e.g., a speaker or the like). The feedback, examples of which are described further below, may indicate that the device 100 and the object 104 should be repositioned relative to one another to successfully dimension the object 104. Following the generation of feedback at block 225, the device 100 returns to block 205, to continue capturing further images and point clouds, and to evaluate those images and point clouds as set out above.

When the quality indicator from block 215 satisfies the predetermined threshold(s), the determination at block 220 is affirmative and the device 100 can proceed to block 230 rather than block 225. At block 230, the device 100 can determine dimensions for the object 104 from the point cloud 304.

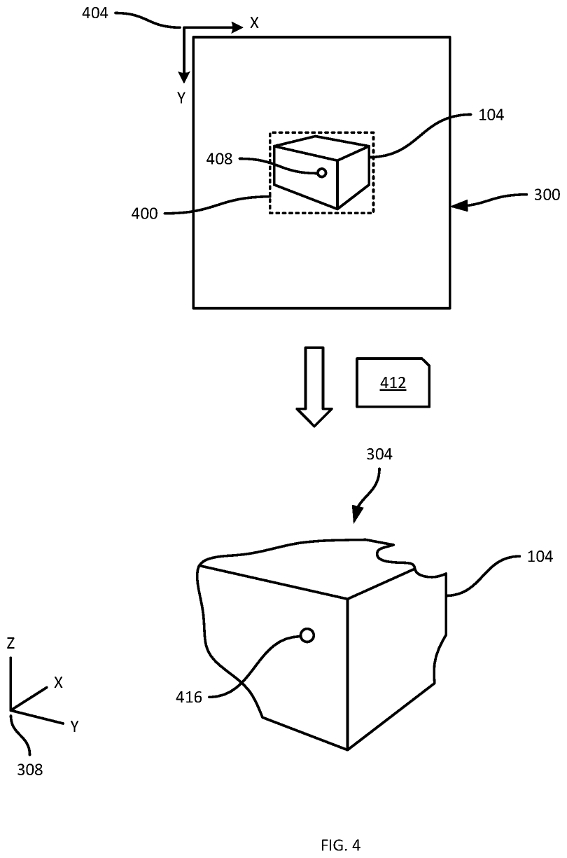

The quality indicator determined at block 215 can take various forms. In some examples, the quality indicator includes a distance from the depth sensor 128 to a portion of the point cloud. For example, as shown in FIG. 4, the device 100 determines an ROI 400 from the 2D image 300, via a suitable segmentation operation. The ROI 400 forms a bounding box containing the object 104 and substantially excluding a remainder of the image 300. In this example, the ROI 400 is a rectangular bounding box with sides parallel to the sides of the image 300. The sides of the ROI 400, in other words, are aligned with the X and Y axes of an image coordinate system 404. The coordinate system 404 can be aligned with axes of the field of view of the sensor 128 and/or 132. In other examples, the coordinate system 404, or other coordinate systems mentioned here, can include object-oriented coordinate systems with axes aligned to the edges of the object 104.

Having determined the ROI 400, the device 100 can be configured to select a pixel within the ROI 400, such as a center pixel 408 of the ROI 400. The device 100 can further be configured to map the ROI 400 and/or the selected pixel 408 to the point cloud 304. That is, the device 100 can transform the pixel coordinates of the pixel 408 (in the coordinate system 404) to coordinates in the coordinate system 308, or to pixel coordinates of the depth sensor 128, from which the coordinate system 308 is derived. In other examples, the device 100 can transform the coordinates of each corner of the ROI 400 into the coordinate system 308 or depth sensor pixel coordinates, in addition to the coordinates of the pixel 408.

Transformation of coordinates from the coordinate system 404 to the coordinate system 308 or pixel coordinates of the depth sensor 128 can be performed by applying a transform, e.g., defined by calibration data 412 stored in the memory 116. The calibration data 412 can be a component of the application 144, for example. The calibration data 412 can define the physical positions of the depth sensor 128 and the image sensor 132 relative to one another. The calibration data can also include other sensor parameters, such as focal length, field of view dimensions, and the like. The calibration data 412 can include, for example, an extrinsic parameter matrix and/or an intrinsic parameter matrix for each of the depth sensor 128 and the image sensor 132.

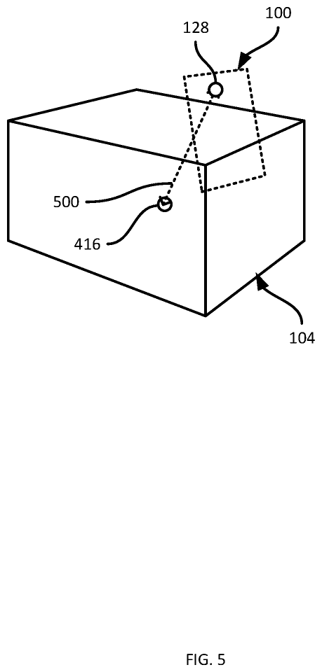

By mapping the ROI 400, or at least the pixel 408, to the point cloud 304, the device 100 determines a portion of the point cloud 304 that corresponds to the same physical space as the mapped ROI 400. For example, the device 100 can determine a point 416 in the point cloud 304 that corresponds to the pixel 408, in that the point 416 and the pixel 408 both correspond to substantially the same portion of the object 104. The device 100 can then determine, based on the point cloud 304, a distance between the depth sensor 128 and the point 416. Turning to FIG. 5, a distance 500 between the point 416 and the depth sensor 128 is illustrated.

At block 220, the device 100 can be configured to compare the distance 500 to at least one predetermined threshold. For example, the device 100 can store either or both of a lower distance threshold and an upper distance threshold. The lower distance threshold indicates a minimum distance between the depth sensor 128 and the object 104 that is likely to permit successful dimensioning of the object 104, and the upper distance threshold indicates a maximum distance between the depth sensor 128 and the object 104 that is likely to permit successful dimensioning of the object 104. The specific thresholds can vary between devices, sensors, and the like. In this example, solely for illustrative purposes, the lower distance threshold can be about 20 cm, and the upper distance threshold can be about 2 m.

The determination at block 220 can therefore include determining whether the distance 500 exceeds the lower threshold, whether the distance 500 is smaller than the upper threshold, or both. If the distance 500 is below the lower threshold or above the upper threshold, the determination at block 220 is negative. In some examples, the threshold(s) applied at block 220 can be predetermined, e.g., based on the range and other parameters of the sensors 128 and/or 132. In other examples, the threshold(s) can be dynamic, e.g., determined for each capture operation based on quality factors of the captured images at block 205.

In other examples, the quality indicator determined at block 215 can include estimated dimensions of the object 104 obtained from the 2D image 300, or from a sequence of successive 2D images. Although the estimated dimensions obtained from the 2D image 300 may be insufficiently accurate for output to downstream applications, the estimated dimensions can be employed at block 220 along with the distance 500 mentioned above. For example, the optimal range of distances between the object 104 and the depth sensor 128 may vary depending on the size of the object. For instance, for an object whose largest dimension between width, height, and depth is about 10 cm, the optimal distance 500 may be between about 20 cm and about 70 cm. For an object whose largest dimension between width, height, and depth is about 60 cm, however, the optimal distance 500 may be between about 50 cm and about 2 m.

The device 100 can determine estimated dimensions from the image 300, for example, by executing a simultaneous localization and mapping (SLAM) function to integrate the image 300 (e.g., as part of a sequence of images captured by the image sensor 132) with motion data from the motion sensor 136. For example, the device 100 can detect features such as corners, edges, or the like in successive images, e.g., tracking those features between images. Based on the tracked image locations of those features, and on the motion data indicating the physical movement of the device 100 (and therefore of the image sensor 132), the device 100 can determine estimated distances between the features. The device 100 can obtain estimated dimensions, for example, by implementing the ARCore™ platform, the ARKit™ platform, or the like.

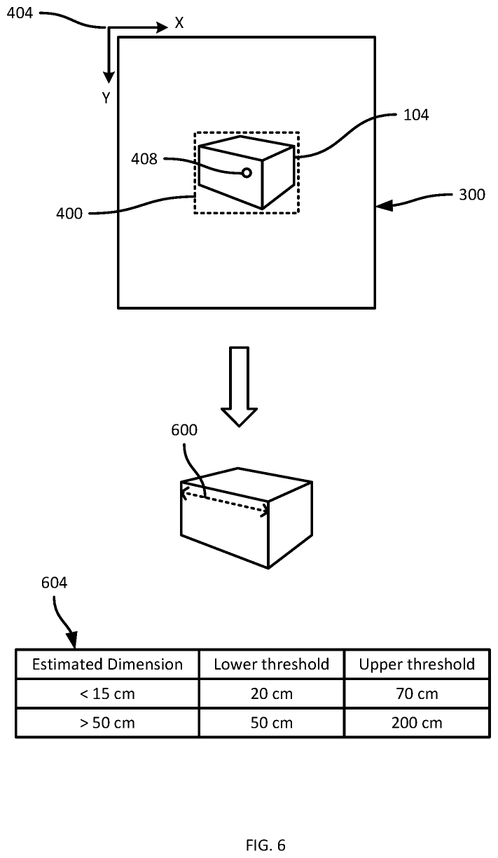

Referring to FIG. 6, the device 100 can obtain an estimated dimension 600 (e.g., the largest estimated dimension of the object 104) that represents an estimated depth of the object 104, from the image 300. The device 100 can obtain other dimensions (such as an estimated width and/or an estimated height) in addition to the dimension 600. The device 100 can then select the predetermined threshold(s) for comparison to the distance 500 from a plurality of stored thresholds 604 according to the estimated dimension 600. As shown in FIG. 6, the stored thresholds 604 include a first lower and upper threshold for objects with an estimated dimension below 15 cm, and a second lower and upper threshold for objects with an estimated dimension above 50 cm. In other examples, the thresholds can correspond to estimated object volumes or the like, instead of selected linear dimensions.

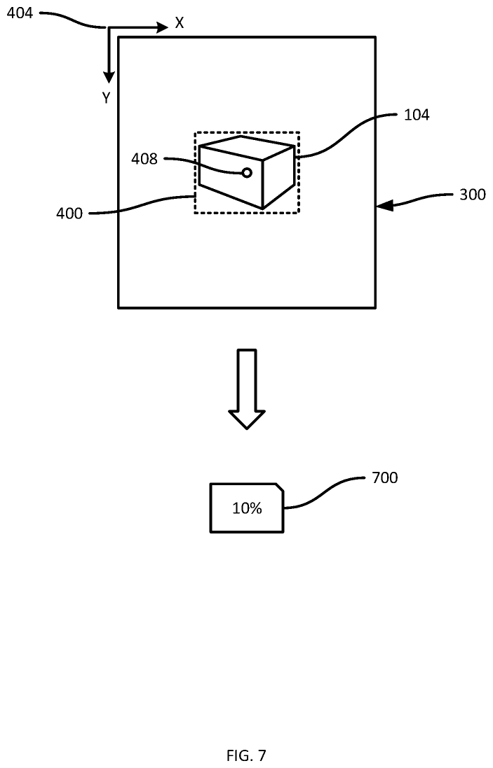

In further examples, at block 215 the quality indicator can include a fraction of the field of view of the image sensor 132 occupied by the ROI 400. For example, the device 100 can determine, based on the image coordinates of the ROI 400, an area of the ROI 400 for comparison to an area of the complete field of view of the image sensor 132. Turning to FIG. 7, the device 100 determines a fraction 700 from the image 300 and the ROI 400, indicating that the ROI 400 occupies about 10 percent of the image 300. At block 220, the device 100 can compare the fraction 700 to one or more predetermined thresholds. For example, the determination at block 220 can be affirmative if the fraction 700 is above a lower threshold (e.g., about 50%) and below an upper threshold (e.g., about 80%). Various other thresholds can also be employed. The use of the fraction 700 instead of the distance 500 and estimated dimension 600 may impose a smaller computational load on the device 100 than the determination of estimated dimension(s) from the image 300. Further, the fields of view of the image sensor 132 and the depth sensor 128 may have similar sizes. In other examples, the coordinates of the ROI 400 can be transformed into a coordinate system of the depth sensor 128, and the fraction 700 can be determined relative to the field of view of the depth sensor 128.

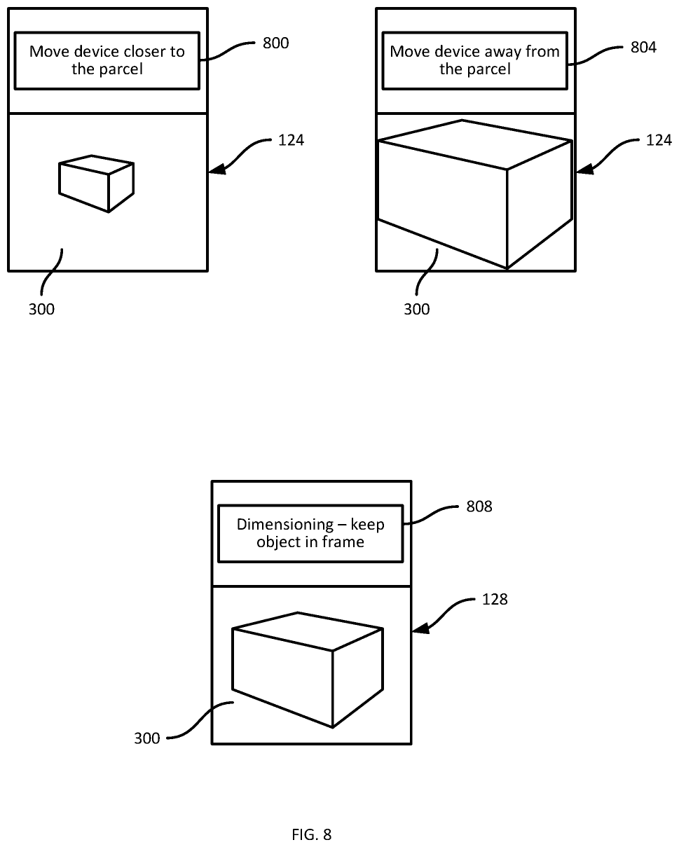

Turning to FIG. 8, examples of feedback generated via block 225 are illustrated. For example, when the determination at block 220 is negative because the distance 500 is above the upper threshold, and/or the fraction 700 is below the lower threshold, the device 100 can present a feedback notification 800. The notification 800 instructs an operator of the device 100 to reduce the distance between the object 104 and the device 100. When the determination at block 220 is negative because the distance 500 is below the lower threshold, and/or the fraction 700 is above the upper threshold, the device 100 can present a feedback notification 804. The notification 804 instructs an operator of the device 100 to increase the distance between the object 104 and the device 100. The notifications 800 and 804 can be presented on the display 124, e.g., along with the image 300 (which, as noted earlier, implements an electronic viewfinder). In some examples, the notifications can be presented via other output devices, such as a speaker, indicator light, or the like. In further examples, the point cloud 304 can also be presented on the display 124, e.g., overlaid on the image 300 or in an inset window.

As also shown in FIG. 8, when the determination at block 220 is affirmative, at block 230 the device 100 can present feedback 808 indicating that the device 100 is in the process of determining dimensions of the object 104 from the point cloud 304. Determination of dimensions can include extracting the portion of the point cloud 304 corresponding to the ROI 400, and performing segmentation and measurement operations on the extracted portion of the point cloud 304. The resulting dimensions (e.g., width, depth, and height of the object 104) can be presented on the display 124 and/or provided to other applications executing on the device 100.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
capturing a three-dimensional image depicting an object;
capturing a two-dimensional image depicting the object;
determining a region of interest in the two-dimensional image, the region of interest containing the object;
determining, based on the region of interest from the two-dimensional image, a quality indicator corresponding to the three-dimensional image;
comparing the quality indicator to a predetermined threshold; and
when the quality indicator does not satisfy the predetermined threshold, generating a positional notification.

2. The method of claim 1, wherein determining the quality indicator comprises:
mapping the region of interest to a portion of the three-dimensional image; and
determining a distance from the depth sensor to the object, based on the portion of the three-dimensional image.

3. The method of claim 2, wherein the predetermined threshold includes a lower distance threshold, and an upper distance threshold; and
wherein the quality indicator satisfies the predetermined threshold when the distance is between the lower distance threshold and the upper distance threshold.

4. The method of claim 2, further comprising:
obtaining motion data via a motion sensor;
determining, based on the two-dimensional image and the motion data, an estimated dimension of the object; and
selecting the predetermined threshold based on the estimated dimension.

5. The method of claim 1, wherein determining the quality indicator comprises:
determining a fraction of a field of view of the image sensor occupied by the region of interest.

6. The method of claim 5, wherein the predetermined threshold includes a lower threshold, and an upper threshold; and
wherein the quality indicator satisfies the predetermined threshold when the fraction is between the lower threshold and the upper threshold.

7. The method of claim 1, further comprising:
when the quality indicator satisfies the predetermined threshold, determining dimensions of the object from the three-dimensional image.

8. The method of claim 1, wherein capturing the three-dimensional image includes capturing a plurality of depth measurements, and generating a point cloud from the depth measurements.

9. A computing device, comprising:
a sensor assembly; and
a processor configured to:
capture, via the sensor assembly, a three-dimensional image depicting an object;
capture, via the sensor assembly, a two-dimensional image depicting the object;
determine a region of interest in the two-dimensional image, the region of interest containing the object;
determine, based on the region of interest from the two-dimensional image, a quality indicator corresponding to the three-dimensional image;
compare the quality indicator to a predetermined threshold; and
when the quality indicator does not satisfy the predetermined threshold, generate a feedback notification.

10. The computing device of claim 9, wherein the processor is configured to determine the quality indicator by:
mapping the region of interest to a portion of the three-dimensional image; and
determining a distance from the sensor assembly to the object, based on the portion of the three-dimensional image.

11. The computing device of claim 10, wherein the predetermined threshold includes a lower distance threshold, and an upper distance threshold; and
wherein the quality indicator satisfies the predetermined threshold when the distance is between the lower distance threshold and the upper distance threshold.

12. The computing device of claim 10, further comprising a motion sensor, wherein the processor is further configured to:
obtain motion data via the motion sensor;
determine, based on the two-dimensional image and the motion data, an estimated dimension of the object; and
select the predetermined threshold based on the estimated dimension.

13. The computing device of claim 9, wherein the processor is configured to determine the quality indicator by:
determining a fraction of a field of view of the sensor assembly occupied by the region of interest.

14. The computing device of claim 13, wherein the predetermined threshold includes a lower threshold, and an upper threshold; and
wherein the quality indicator satisfies the predetermined threshold when the fraction is between the lower threshold and the upper threshold.

15. The computing device of claim 9, wherein the processor is configured to:
when the quality indicator satisfies the predetermined threshold, determining dimensions of the object from the three-dimensional image.

16. The computing device of claim 9, wherein the sensor assembly comprises a depth sensor configured to capture the three-dimensional image, and an image sensor configured to capture the two-dimensional image.

17. The computing device of claim 9, wherein the sensor assembly includes a sensor configured to capture the three-dimensional image and the two-dimensional image.

18. A method, comprising:
obtaining a point cloud depicting an object;
obtaining a two-dimensional image of the object;
detecting the object in the two-dimensional image;
based on the detected object in the two-dimensional image, determining a quality indicator configured to indicate a likelihood that dimensions of the object can be obtained from the point cloud; and
selecting, based on the quality indicator, between (i) generating feedback to reposition a sensor relative to the object and (ii) obtaining dimensions of the object from the point cloud.
